(19) United States
(12) Patent Application Publication
(10) Pub. No.: US 2009/0324957 A1
(43) Pub. Date: Dec. 31, 2009

(54) CONDUCTIVE, ORGANIC COATINGS HAVING AN OPTIMIZED POLYMER SYSTEM

(75) Inventors: Eva Wilke, Haan (DE); Manuela Göske-Krajnc, Hilden (DE); Reiner Wark, Wuppertal (DE); Guadalupe Sanchis Otero, Duesseldorf (DE); Stephan Müller, Monheim (DE); Marcel Roth, Duesseldorf (DE); Wolfgang Lorenz, Erkrath (DE); Karsten Hackbarth, Duesseldorf (DE); Andreas Kunz, Remscheid (DE)

Correspondence Address: HENKEL CORPORATION, One Henkel Way, ROCKY HILL, CT, 06067, US

(73) Assignee: Henkel AG & Co. KGaA, Dusseldorf (DE)

(21) Appl. No.: 12/494,682

(22) Filed: Jun. 30, 2009

Related U.S. Application Data
(63) Continuation of application No. PCT/EP2007/061305, filed on Oct. 23, 2007.

(30) Foreign Application Priority Data
Jan. 4, 2007 (DE) 102007001654.0

(51) Int. Cl. B32B 27/38; C08L 67/00; C08K 3/34; C08K 3/22; C08K 3/30; B05D 3/00; B05D 3/02

(52) U.S. Cl. 428/413; 524/539; 524/442; 524/430; 524/423; 427/327; 427/386

(57) ABSTRACT

A substance for coating metal surfaces, comprising organic resin components that are dissolved or dispersed in an organic solvent, or solvent mixture, having at least the following organic resin components: a) epoxy resin, present as polyether comprising hydroxyl groups, based on a bisphenol epichlorohydrin polycondensation product, b) blocked aliphatic polyisocyanate, c) unblocked aliphatic polyisocyanate, d) at least one reaction component, selected from polyesters comprising hydroxyl groups and poly(meth)acrylates comprising hydroxyl groups. The substance may also comprise at least one conductivity pigment. The invention further provides a method for coating a sheet metal with this substance, the respectively coated sheet metal, and the use thereof.

This application is a continuation under 35 U.S.C. Sections 365(c) and 120 of International Application No. PCT/EP2007/061305, filed Oct. 23, 2007 and published on Jul. 10, 2008 as WO 2008/080647, which claims priority from German Patent Application No. 102007001654.0 filed Jan. 4, 2007, which are incorporated herein by reference in their entirety.

The present invention relates to conductive and weldable anti-corrosion coatings of metal surfaces as well as a process for coating metal surfaces with electrically conductive organic coatings.

In the context of the present invention, a coating is understood to be electrically conductive, when it can be welded, after curing, under the usual conditions of joint technology in the automobile industry, preferably in a spot-welding process. In addition, the conductivity should be sufficient to enable a complete deposition of this coating under typical deposition conditions of electro-dip coating.

In the metalworking industry, particularly in automobile construction, the metal parts of the products have to be protected against corrosion. According to the conventional prior art, the sheet metal is first coated with anti-corrosion oils in the rolling mill and optionally coated with drawing compounds prior to forming and stamping. In the vehicle construction sector, appropriately shaped sheet metal parts are stamped out for vehicle bodies or body parts and shaped using such drawing compounds or oils in a deep-drawing process, then they are assembled, generally by means of welding and/or flanging and/or bonding, and finally cleansed in a costly procedure. Anti-corrosion surface pre-treatments, such as phosphating and/or chromating, then follow, whereupon a first paint layer is applied to the structural parts by electro-deposition. In general, this first electro-deposition process, especially in the case of car bodies, is followed by the application of several more layers of paint.

In the metal processing industry, such as in the vehicle and domestic appliance construction sectors, in order to simplify the process, there is a need to reduce the cost of chemical anti-corrosion treatment. This may be achieved by providing the raw material in the form of metal sheets or metal strips which have already been provided with an anti-corrosion layer.

There is, therefore, a need to find simpler methods of production, in which pre-coated sheets may be formed, welded and then painted in an electro-deposition process in a well-proven manner. Thus, there are a number of processes in which an organic, more or less conductive coating is applied, subsequent to phosphatization and/or chromation in a so-called coil coating process. As a rule, these organic coatings should be made up in such a way that they are sufficiently electrically conductive so as not impair the typical welding processes used in the car industry, for example electrical spot-welding. In addition, these coatings should be overpaintable with conventional electro deposition paints.

Recently, particularly in the car industry, in addition to normal steel sheet, steel sheets, which have been galvanized and/or alloy galvanized in a variety of processes, have also found increasing use.

The coating of steel sheeting with organic coatings that are weldable and which are applied directly in the rolling mill by the so-called coil-coating process is known in principle.

Thus, German patent DE-C-3412234 describes a conductive and weldable anti-corrosion primer for electrolytically thin-layer galvanized, phosphatized or chromated and drawable steel sheeting. This anti-corrosion primer consists of a mixture of more than 60% zinc, aluminum, graphite and/or molybdenum disulfide and also another anti-corrosion pigment and 33 to 35% of an organic binder and about 2% of a dispersion auxiliary or catalyst. Polyester resins and/or epoxy resins and derivatives thereof are proposed as the organic binders. Specific examples mentioned are an epoxide/phenyl pre-condensate, an epoxy ester and linear, oil-free mixed polyesters based on terephthalic acid.

The European patent application EP-A-573015 describes an organic-coated steel composite sheet, consisting of surfaces coated with zinc or a zinc alloy on one or two sides, provided with a chromate film and an organic coating applied thereto with a wall thickness of 0.1 to 5 μm. The organic coating is formed from a primer composition that consists of an organic solvent, an epoxy resin having a molecular weight between 500 and 10 000, an aromatic polyamine and a phenol or cresol compound as accelerator. In addition, the primer composition comprises a polyisocyanate and colloidal silica.

In an analogous manner, the German patent application DE-A-3640662 describes a surface-treated steel sheet comprising a zinc-coated or zinc alloy-coated steel sheet, a chromate film produced on the surface of the steel sheet and a layer of a resin composition produced on the chromate film. This resin composition consists of a basic resin that is prepared by reacting an epoxy resin with amines, and a polyisocyanate compound.

WO 99/24515 discloses a conductive and weldable anti-corrosion composition for coating metal surfaces, comprising
a) 10 to 40 wt. % of an organic binder, comprising
   aa) at least one epoxy resin
   ab) at least one curing agent selected from guanidine, substituted guanidines, substituted ureas, cyclic tertiary amines and their mixtures
   ac) at least one blocked polyurethane resin
b) 0 to 15 wt. % of an anti-corrosion pigment based on silicate
c) 40 to 70 wt. % of powdered zinc, aluminum, graphite and/or molybdenum sulfide, carbon black, iron phosphide
d) 0 to 30 wt. % of a solvent.

WO 01/85860 relates to a conductive and weldable anti-corrosion composition for coating metal surfaces, comprising, based on the total composition,
a) 5 to 40 wt. % of an organic binder, comprising
   aa) at least one epoxy resin
   ab) at least one curing agent selected from cyanoguanidine, benzoguanamine and plasticized urea resin
   ac) at least one amine adduct selected from polyoxyalkylenetriamine and epoxy resin-amine adducts
b) 0 to 15 wt. % of an anti-corrosion pigment
c) 40 to 70 wt. % conductive pigment, selected from powdered zinc, aluminum, graphite, molybdenum sulfide, carbon black and iron phosphide
d) 0 to 45 wt. % of a solvent
   as well as, when required, up to 50 wt. % additional active or auxiliary agents, wherein the amounts of the components add up to 100 wt. %.

In spite of the extensive prior art, there still remains a need to further improve the known weldable anti-corrosion coatings. In addition the weldable coatings should exhibit good slip properties such that if possible, the coated sheets can be shaped without any lubrication. By this means, firstly one can economize on forming oil and secondly the required cleaning prior to a further overcoating can be simplified. This allows the materials consumption to be reduced during the whole production chain. The object of the present invention is to provide a coating agent as well as a coating process, which realize the cited advantages.

Accordingly, in a first aspect, the present invention relates to an agent for coating metal surfaces which comprises organic resin components dissolved or dispersed in an organic solvent or mixture of solvents, wherein the agent comprises at least the following organic resin components:
a) an epoxy resin based on a bisphenol-epichlorohydrin polycondensation product and present as a hydroxyl group-containing polyether,
b) blocked aliphatic polyisocyanate,
c) unblocked aliphatic polyisocyanate,
d) at least one reaction component selected from hydroxyl group-containing polyesters and hydroxyl group-containing poly(meth)acrylates.

The component a) concerns a thoroughly reacted polycondensation product of epichlorohydrin and a bisphenol. It possesses essentially no more epoxy groups as the reactive groups. The polymer then exists in the form of a hydroxyl group-containing polyether that can undergo crosslinking reactions through these hydroxyl groups with polyisocyanates for example.

The bisphenol component of this polymer can be selected for example from Bisphenol A and Bisphenol F. The mean molecular weight (according to manufacturers' data, e.g. determined by gel permeation chromatography) is preferably in the range 20 000 to 60 000, particularly in the range 30 000 to 50 000. The OH number is preferably in the range 170 to 210 and particularly in the range 180 to 200. Particularly preferred polymers have a hydroxyl content in the range 5 to 7 wt. % based on the ether resin.

The aliphatic polyisocyanates b) and c) are preferably based on HDI, especially on HDI-trimer. Usual polyisocyanate blocking agents can be employed as the blocking agent in the blocked aliphatic polyisocyanate b). The following examples may be cited: butanone oxime, dimethylpyrazole, malonic esters, diisopropylamine/malonic esters, diisopropylamine/triazole as well as ε-caprolactam. Preferably, a combination of malonic ester and diisopropylamine is used as the blocking agent.

The content of blocked NCO groups of component b) is preferably in the range 8 to 10 wt. %, particularly in the range 8.5 to 9.5 wt. %. The equivalent weight is preferably in the range 350 to 600, particularly in the range 450 to 500 g/mol.

The unblocked aliphatic polyisocyanate c) has preferably an equivalent weight in the range 200 to 250 g/mol and an NCO content in the range 15 to 23 wt. %. For example, an aliphatic polyisocyanate can be selected which possesses an equivalent weight in the range 200 to 230 g/mol, in particular in the range 210 to 220 g/mol and an NCO content in the range 18 to 22 wt. %, preferably in the range 19 to 21 wt. %. Another suitable aliphatic polyisocyanate has for example an equivalent weight in the range 220 to 250 g/mol, in particular in the range 230 to 240 g/mol and an NCO content in the range 15 to 20 wt. %, preferably in the range 16.5 to 19 wt. %. Each of these cited aliphatic polyisocyanates can represent the component c). However, a mixture of both of these polyisocyanates can also be present as the component c). If a mixture of both of the cited polyisocyanates is employed, then the proportion of the first polyisocyanate to the second polyisocyanate in the component c) is preferably in the range 1:1 to 1:3.

The component d) is selected from hydroxyl group-containing polyesters and hydroxyl group-containing poly(meth)acrylates. For example, a hydroxyl group-containing poly(meth)acrylate having an acid number in the range 3 to 12, particularly in the range 4 to 9 mg KOH/g, can be employed. The hydroxyl group content is preferably in the range 1 to 5 and particularly in the range 2 to 4 wt. %. The equivalent weight is preferably in the range 500 to 700, particularly in the range 550 to 600 g/mol.

If a hydroxyl group-containing polyester is employed as the component d), then a branched polyester having an equivalent weight in the range 200 to 300, particularly in the range 240 to 280 g/mol, can be selected. Moreover, a slightly branched polyester with an equivalent weight in the range 300 to 500, particularly in the range 350 to 450 g/mol, is suitable for example. These different polyester types can each be used per se or as a mixture for the component d). Naturally, a mixture of hydroxyl group-containing polyesters and hydroxyl group-containing poly(meth)acrylates can also form the component d).

Accordingly, the agent according to the invention comprises both a blocked aliphatic polyisocyanate b) as well as an unblocked aliphatic polyisocyanate c). The hydroxyl group-containing components a) and d) are available as potential reaction components for both of these polyisocyanate types. On curing, a complex polymer network of polyurethanes results from the possible reaction of each of the components a) and d) with each of the components b) and c). In addition, in the case that hydroxyl group-containing poly(meth)acrylates are used as the component d), further crosslinks can occur through the double bonds of these components. When not all the double bonds of the poly(meth)acrylates crosslink on curing, then the double bonds present, in particular at the surface, can result in an improved bonding to a subsequently deposited paint—in the case that the paint likewise comprises components that contain polymerizable double bonds. With this in mind, the component d) preferably consists, at least partially, of hydroxyl group-containing poly(meth)acrylates.

On crosslinking the agent according to the invention it is to be expected that initially, the unblocked aliphatic polyisocyanate c) reacts with one or both of the components a) and d). In so far as the hydroxyl groups of the component d) are more reactive than those of the component a), then on curing, the component c) initially reacts preferentially with the component d).

In contrast, the blocked aliphatic polyisocyanate b) then only reacts with one or both of the components a) and d) once the deblocking temperature is reached. Then, only those reaction partners a) and d) that possess less reactive OH groups remain available for polyurethane formation. For the polyurethane network under formation, this means, for example, that if the OH groups of component a) are more reactive than those of component d), then two polyurethane networks are formed from the reaction of components c) and d) on the one hand and from components a) and b) on the other hand.

The inventive agent preferably comprises on the one hand the components a) and b) and on the other hand c) and d) in the following weight ratios:

a):b)=1:0.8 to 1:1.3

c):d)=1:1.4 to 1:2.3

The components a) and d) on the one hand and b) and c) on the other hand are preferably present in the following relative weight ratio:

a):d)=1:2 to 1:6 and (preferably 1:3 to 1:5)

b):c)=1:0.5 to 1:5 (preferably 1:1 to 1:3).

Preferred absolute quantitative ranges of the four cited components a) to d) are presented further below as they depend on the density of the optionally present conductive pigments. The inventive agent preferably comprises a conductive pigment or a mixture of conductive pigments in addition to the components a) to d). Said pigments can have a relatively low density, such as for example carbon black and graphite, or a relatively high density, such as for example metallic iron. The absolute content of the conductive pigments in the inventive agent depends on the density of the pigments, as the effect of the conductive pigment depends less on the weight fraction than much more on the volume fraction of the conductive pigment in the cured coating.

In general, this means that the inventive agent comprises, based on the total weight of the agent, (0.8 to 8)ρ wt. % of conductive pigment, wherein ρ means the density of the conductive pigment or the mean density of the mixture of conductive pigments in g/cm³. The agent preferably comprises (2 to 6)ρ wt. %, based on its total weight, of conductive pigment.

This means for example: if the agent comprises only graphite with a density of 2.2 g/cm³ as the conductive pigment, then it preferably comprises at least 1.76, especially at least 4.4 wt. % and preferably not more than 17.6, especially not more than 13.2 wt. % graphite. If iron powder with a density of 7.9 g/cm³ were used as the sole conductive pigment, then the agent, based on its total weight, preferably comprises at least 6.32, especially at least 15.8 wt. % and not more than 63.2, in particular not more than 47.4 wt. %. The weight fractions are calculated in the same way if for example exclusively MoS₂ with a density of 4.8 g/cm³, aluminum with a density of 2.7 g/cm³ or zinc with a density of 7.1 g/cm³ are used as the conductive pigment.

However, a favorable combination of characteristics can be achieved if the inventive agent comprises not only a single conductive pigment but rather a mixture of at least 2 conductive pigments that preferably strongly differ in their density. For example, a mixture can be used, in which the first component of the mixture is a low density conductive pigment such as for example carbon black, graphite or aluminum, and the second component of the mixture is a dense conductive pigment such as for example zinc or iron. In these cases the average density of the mixture is used for the density ρ in the abovementioned formula, said average density being calculated from the weight fractions of the components in the mixture and from their respective densities.

Consequently, a specific embodiment of an inventive agent is characterized in that it comprises both a conductive pigment with a density of less than 3 g/cm³ as well as a conductive pigment with a density greater than 4 g/cm³, wherein the total amount of conductive pigment, based on the total weight of the agent, is (0.8 to 8)ρ wt. %, wherein ρ means the average density of the mixture of the conductive pigments in g/cm³.

For example, the inventive agent can comprise a mixture of carbon black or graphite on the one hand and iron powder on the other hand as the conductive pigment. In this case the weight ratios of carbon black and/or graphite on the one hand and iron on the other hand can range from 1:0.1 to 1:10, in particular in the range 1:0.5 to 1:2.

The agent can thus comprise aluminum flakes, graphite and/or carbon black as the low density electrically conductive pigment. The use of graphite and/or carbon black is preferred. Carbon black and particularly graphite not only produce an electrical conductivity of the resulting coating but in addition also make a contribution such that this layer exhibits the required low Moh hardness of not more than 4 and can be easily shaped. In particular, the lubricating effect of graphite contributes to a lower wear of the forming tools. This effect can be further promoted by the concomitant use of additional lubricating pigments such as for example molybdenum sulfide. The agent can comprise waxes and/or Teflon as additional lubricants or forming aids.

The electrically conductive pigment with a density of maximum 3 g/cm³ can be in the form of small spheres or aggregates of such spheres. It is preferred that the diameter of the spheres or of the aggregates of these spheres is less than 2 μm. Preferably however, these electrically conductive pigments are in the form of platelets with a thickness of preferably less than 2 μm.

The inventive agent comprises at least the resin components described above as well as solvent. In general, the resin components a) to d) are commercially available in the form of a solution or dispersion in organic solvents. The inventive agent prepared from them then likewise comprises these solvents.

These are desirable in order to be able, in spite of the additional presence of the electrically conductive pigment, such as for example graphite and optionally additional pigments, such as in particular corrosion-protection pigments, to adjust a viscosity that enables the coating agent to be applied onto the substrate in the coil coating process. When necessary, additional solvent can be added. The chemical nature of the solvent is generally predetermined by the choice of the raw materials that comprise the corresponding solvent. Exemplary solvents that can be present are: cyclohexanone, diacetone alcohol, diethylene glycol monobutyl ether acetate, diethylene glycol, propylene glycol methyl ether, propylene glycol n-butyl ether, methoxypropyl acetate, n-butyl acetate, xylene, dimethyl glutarate, dimethyl adipate and/or dimethyl succinate.

The preferred content of solvent on the one hand and organic resin components on the other hand in the inventive agent depends, expressed in wt. %, on the fraction of conductive pigment in wt. % in the agent. The higher the density of the conductive pigment, the higher is its preferred weight fraction in the total agent, and the lower the weight fractions of solvent and resin components. The preferred weight fractions of solvent and resin components therefore depend on the density ρ of the added conductive pigment or the average density ρ of a mixture of conductive pigments.

In general, the inventive agent preferably comprises, based on the total weight of the agent, [(25 to 60)·adjustment coefficient] wt. %, preferably [(35 to 55)·adjustment coefficient] wt. % organic solvent and [(20 to 45)·adjustment coefficient] wt. %, preferably [(25 to 40)·adjustment coefficient] wt. % organic resin components, wherein the sum of the weight fractions of organic resin components and solvent is not greater than [93·adjustment coefficient] wt. %, preferably not greater than [87·adjustment coefficient] wt. % and wherein the adjustment coefficient is [100-2.8ρ]: 93.85 and ρ means the density of the conductive pigment or the average density of the mixture of conductive pigments in g/cm³.

In regard to the individual resin components a), the agent preferably comprises, based on the total weight of the agent, [(2 to 8)·adjustment coefficient] wt. %, preferably [(3 to 5)·adjustment coefficient] wt. % of the resin component a), wherein the adjustment coefficient is [100-2.8ρ]: 93.85 and ρ means the density of the conductive pigment or the mean density of the mixture of conductive pigments in g/cm³. The preferred weight fractions of the resin components b) to d) in the inventive agent can be calculated from the weight fraction of the resin component a) using the abovementioned preferred weight ratios of the individual resin components. For example, the fraction of component b) in the total weight of the agent can be [(2 to 9)·adjustment coefficient] wt. %, preferably [(3 to 6)·adjustment coefficient] wt. %, the fraction of the resin component c) [(4 to 18)·adjustment coefficient] wt. %, preferably [(6 to 12)·adjustment coefficient] wt. % and the fraction of the resin component d) [(7 to 30)·adjustment coefficient] wt. %, preferably [(10 to 20)·adjustment coefficient] wt. %. The “adjustment coefficient” has the same meaning as described above.

In addition, the layer b) preferably comprises further corrosion inhibitors and/or anti-corrosion pigments. Corrosion inhibitors and/or anti-corrosion pigments that are known for this purpose in the prior art can be employed. The following examples may be cited: magnesium oxide pigments, particularly in nanomeric form, finely divided and very finely divided barium sulfate or corrosion-protection pigments based on calcium silicate. The preferred weight fraction of the corrosion-protection pigments in the total weight of the agent depends once again on the density of the added corrosion-protection pigment. The agent preferably comprises, based on the total weight of the agent, [(5 to 25)·adjustment coefficient] wt. %, preferably [(10 to 20)·adjustment coefficient] wt. % of the corrosion-protection pigment, wherein the adjustment coefficient is [100-2.8ρ]: 93.85 and ρ means the density of the conductive pigment or the mean density of the mixture of conductive pigments in g/cm³.

The mechanical and chemical properties of the resulting coating after baking the inventive agent can be further improved when additional fillers are comprised. For example, these can be selected from silicic acids or silicon oxides (optionally hydrophobized), aluminum oxides (including basic aluminum oxide), titanium dioxide and barium sulfate. In regard to their preferred quantities, the agent preferably comprises, based on the total weight of the agent, [(0.1 to 3)·adjustment coefficient] wt. %, preferably [(0.4 to 2)·adjustment coefficient] wt. % filler, selected from silicic acids or silicon oxides, aluminum oxides, titanium dioxide and barium sulfate, wherein the adjustment coefficient is [100-2.8ρ]: 93.85 and ρ means the density of the conductive pigment or the mean density of the mixture of conductive pigments in g/cm³.

When lubricants or shaping aids are also employed, then the agent preferably comprises, based on its total weight, lubricants or shaping aids, preferably selected from waxes, molybdenum sulfide and Teflon, preferably in a quantity of [(0.5 to 20)·adjustment coefficient] wt. %, preferably [(1 to 10)·adjustment coefficient] wt. %, wherein the adjustment coefficient is [100-2.8ρ]: 93.85 and ρ means the density of the conductive pigment or the mean density of the mixture of conductive pigments in g/cm³.

In another preferred embodiment, the agent does not comprise any conductive pigment. This is understood to mean that a pigment of this type is not deliberately added. However, due to contamination, minor amounts of electrically conductive pigments may be fortuitously present. Their content in the agent should, however, not exceed 0.1 wt. %.

However, all of the other previously cited components could be present in this conductive pigment-free agent. The preferred weight fractions are obtained from the previously expressed equations by setting the adjustment coefficient=1 in each case.

A further subject of the present invention is a process for manufacturing a coated metal panel or metal component, wherein the panel or component to be coated
i) is cleaned, when necessary,
ii) is brought into contact with a conversion solution that generates the conversion layer and which comprises not more than 1 mg chromium per m², and then with or without an intervening rinse
iii) is coated with an agent according to the above description and cured at a substrate temperature in the range 120 to 260° C.

The agent is preferably cured at a substrate temperature in the range 150 to 170° C.

Preferably at least steps ii) and iii) are performed as strip treatment methods, wherein in step iii) the liquid treatment agent is applied in a quantity such that after curing, a layer thickness in the range from 0.5 to 10 μm is obtained. Thus, the agent is preferably applied in the so-called coil coating process. In this process, continuous metal strips are continuously coated. The coating agent can be applied by various processes that are commonly used in the prior art. For example, applicator rolls can be used by which the required wet film thickness can be directly adjusted. As an alternative, the metal strip can be immersed in the coating agent or sprayed with the coating agent, whereupon the required wet film thickness is adjusted by means of consolidation rollers.

Whenever metal strips are coated, which immediately beforehand were electrolytically coated or coated in the melt dip coating process with a metal layer, for example with zinc or zinc alloys, then the metal surfaces do not need to be cleaned prior to carrying out the conversion treatment (ii). However, when the metal strips have already been stored and particularly when they have been provided with corrosion-protective oils, then a cleaning step is required before carrying out step (ii).

After applying the liquid treatment agent in step (iii), the coated panel is heated to the required drying or crosslinking temperature for the organic coating. Heating the coated substrate to the required substrate temperature (Peak metal Temperature=TMP) from 120 to 260° C., preferably from 150 to 170° C., can be carried out in a heated continuous reheating furnace. However, the treatment agent can also be brought to the suitable drying or crosslinking temperature by means of infrared radiation, particularly by means of near infrared radiation.

The conversion solution employed in step (ii) can be a film-forming or non-film forming phosphatizing solution known in the prior art. Alternatively, an acidic treatment solution can be employed, which comprises complex fluorides of silicon and especially of titanium and/or zirconium as the film-forming component. Moreover, the conversion solution can comprise organic polymers such as for example polyacrylates or amino substituted polyvinylphenol derivatives. An addition of nanomeric silica or nanomeric aluminum oxide to the conversion solution in step (ii) can lead to further improved corrosion protection and adhesion properties. In this context, “nanomeric” particles are understood to mean particles in the agent exhibiting a mean particle diameter of less than 1000 nm, especially less than 500 nm.

In step iii) an agent can be optionally added that comprises at least one conductive pigment or that does not comprise such a conductive pigment. When using an agent without conductive pigment, then the agent is preferably applied in step iii) with a wet film thickness such that after curing a coating thickness of 0.5 to 3 μm, preferably 1 to 3 μm, is obtained. The resulting coating is sufficiently electrically conductive to permit the assembly of the coated panels by electro-welding.

As is usual in automobile construction, the metallic material can be selected from aluminum or an aluminum alloy, zinc or a zinc alloy, steel or steel coated with zinc, with aluminum, or with alloys of zinc or aluminum.

Moreover, the present invention relates to a coated panel or component that is obtained according to the above-described process.

The inventively coated panels find use preferably in automobile construction and in the domestic appliance industry as well as in the manufacture of furniture or architectural parts. In these cases, after having produced the corresponding objects from the inventively coated panels, it is normally the case that one or more additional coating layers are applied. In the automobile construction industry this is normally carried out by cathodic electro deposition painting, which is made possible by the electrical conductivity of the coating. The additional painting steps typical of the automobile industry then follow on. For simpler corrosion-protection specifications such as for example in the domestic appliance industry, a powder coating can be applied as a topcoat onto the inventively deposited layer.

### EXAMPLES

The invention will now be described in more detail by means of several examples.

### a) Pre-Treatment

A commercial pre-treatment solution based on phosphoric acid, manganese phosphate, H₂TiF₆ and aminomethyl-substituted polyvinylphenol (Granodine® 1455 from the applicant) was applied to a galvanized metal sheet that had been cleaned with alkaline cleaners (e.g. Ridoline® C 72, Ridoline® 1340; dip/spray-cleansing products of the applicant), and dispersed over the metal surface by means of a coating wiper or a Chemcoater. The product was then dried at 80° C.

### b) Manufacturing Procedure and Application of the Anti-Corrosion Composition:

The corrosion-protection pigment (mixture) was finely dispersed in the organic binders at room temperature in a dissolver vessel; this can take 10 to 60 minutes. The conductive pigment was then incorporated and dispersed with slow stirring until completely wetted. This can also take 10 to 60 minutes. Optional solvent and further additives were then admixed.

The corrosion-protection composition was applied onto the pre-treated panel with a doctor blade or a roll coater and cured by heating in the drying oven to the substrate temperature given in the tables.

### Test Method:

### Corrosion Test [According to DIN 50021]:

The edges and the back of the coated test panel were masked with adhesive tape. A freshly cut edge was produced on one long side. The sheet was then scored. Finally, the test panel was placed in the salt spray test equipment. The degree of rust was determined periodically at the score, edge and on the panel surface. The number of hours for the red rust to appear on the test panels is given in the tables.

### MEK Resistance:

A block weighing 1 kg was wrapped in cotton wool dipped in methyl ethyl ketone (MEK) and guided over the test surface coated with the anti-corrosion composition. The number of double passes required to remove the coating to make visible the metallic subsurface was counted and reflects the solvent resistance.

T-Bend-Test: Acc. ECCA-Test Method T7 [1996]: “Resistance to Cracking on Bending”

The coated panel was bent 180° with a mechanical press brake. An adhesive tape (Tesafilm 4104) was stuck to the edge and ripped off. Crack formation on the bent edge was determined according to DIN 53230.

Reverse Impact-Test: Acc. ECCA Test Method T5 [1985]: “Resistance to Crack Formation Under Fast Deformation”

The panel coated on one side was deformed by means of a variable impact tester (weight 2 kg; height 1 m). An adhesive tape (Tesafilm 4104) was stuck to the resulting bulge and ripped off. The quantity of coating that was removed by the adhesive tape was determined visually according to an evaluation scale of 1 to 5. The following meanings apply: 1: no coating removed; 5: coating largely removed.

### Resistance to Alkali:

In accordance with the reverse impact test, the panel coated on one side was deformed. The deformed part was dipped into a 70-80° C. warm alkaline cleaning solution (Ridoline® C72, 1% conc., pH ca. 13). An adhesive tape (Tesafilm 4104) was stuck to the resulting bulge and ripped off. The quantity of coating that was removed by the adhesive tape was determined visually according to an evaluation scale of 1 to 5. The following meanings apply: 1:1: no coating removed; 5: coating largely removed.

### Welding Tests:

Electro-welding tests were carried out with a welding machine from Dalex (type: PMS 11-4) under typical automobile conditions. Welding spots were determined according to the Daimler-Chrysler specification DBL 4062/4066. This means that the sheets coated with the inventive anti-corrosion composition are electro-weldable under practical conditions with an adequate electrode life.

Details of the composition of the inventive anti-corrosion compositions and test results can be found in the following tables.

TABLE 1

| Component no. | Ex. 1 | Ex. 2 | Ex. 3 | Ex. 4 | Ex. 5 | Ex. 6 |
|---|---|---|---|---|---|---|
| 1 | 2.75 | 4.67 | 4.58 | 4.49 | 3.81 | 4.14 |
| 2 | 3.01 | 5.11 | 5.01 | 4.91 | 4.14 | 4.54 |
| 3 | 3.60 | 3.06 | 3.00 | 2.94 | 2.46 | 2.69 |
| 4 | 7.74 | 6.57 | 6.44 | 6.32 | 5.28 | 5.77 |
| 5 | 21.06 | 17.89 | 17.54 | 17.20 | 14.38 | 15.66 |
| 6 | 0.33 | 0.29 | 0.28 | 0.28 | 0.27 | 0.28 |
| 7 | 22.00 | 11.30 | 21.57 | 21.15 | 26.74 | 24.69 |
| 8 | | 10.70 | | | 8.60 | 6.49 |
| 9 | 15.00 | 15.00 | 14.71 | 14.42 | 11.99 | 14.69 |
| 10 | 0.70 | 0.70 | 0.69 | 0.67 | 0.57 | 0.60 |
| 11 | 7.00 | 7.00 | 6.86 | 6.73 | 5.66 | 6.15 |
| 12 | | | | 0.86 | | |
| 13 | | | 0.98 | | 0.90 | |
| Solvent from | 16.81 | 17.71 | 18.34 | 20.03 | 15.20 | 14.30 |
| raw materials | | | | | | |
| Sum | 100.00 | 100.00 | 100.00 | 100.00 | 100.00 | 100.00 |

TABLE 2

| Formulation data | 1 | 2 | 3 | 4 | 5 | 6 |
|---|---|---|---|---|---|---|
| Solids | 61.19 | 60.29 | 60.09 | 58.82 | 49.46 | 54.52 |
| P/B ratio | 0.59 | 0.60 | 0.59 | 0.59 | 0.58 | 0.65 |
| Binder fraction solid | 38.49 | 37.59 | 37.83 | 37.00 | 31.24 | 33.08 |
| Corrosion-protection | 15.00 | 15.00 | 14.71 | 14.42 | 11.99 | 14.69 |
| pigment | | | | | | |
| Pigment fraction | 22.70 | 22.70 | 22.26 | 21.82 | 18.22 | 21.44 |
| Solvent | 38.81 | 39.71 | 39.91 | 41.18 | 50.54 | 45.48 |

TABLE 3

| Properties | 1 | 2 | 3 | 4 | 5 | 6 |
|---|---|---|---|---|---|---|
| PMT/° C. | 160 | 160 | 160 | 160 | 160 | 160 |
| Open time | ca. 48 h | ca. 36 h | ca. 48 h | ca. 48 h | ca. 48 h | ca. 48 h |
| t-bend | 1 | 1-2 | 2-3 | 1 | 1-2 | 1 |
| Reverse | 1-1 | 1-2 | 3 | 1 | 2 | 1 |
| impact | | | | | | |
| MEK | 10 | 11 | 8 | 9 | 9 | 5 |
| Alkali | 1-2 | 1-2 | 2-3 | 2 | 2 | 1-2 |
| resistance | | | | | | |
| Corrosion | 1000 | 1000 | 1000++ | 1000 | 1000 | 1000 |
| protection | | | | | | |

The following abbreviations are used:
PMT: Peak Metal Temperature: The highest substrate temperature during curing of the coating,
MEK: MEK resistance according to the above description.

The following meanings apply:

| Component | |
|---|---|
| No. | Description/Identification |
| 1 | Modified epoxy resin, (50% conc. dispersion in solvent mixture): hydroxyl |
| | group-containing polyether without epoxy groups, reaction product of |
| | Bisphenol A and epichlorohydrin, average mol. wt. 40 000, OH number |
| | ca. 190 |
| 2 | Blocked aliphatic polyisocyanate based on HDI, 70% in solvent |
| 3 | Aliphatic polyisocyanate (HDI trimer), (90% in solvent mixture): NCO |
| | content ca. 19.3 to 19.9%, equivalent weight ca. 214 g/mol |
| 4 | Aliphatic polyisocyanate (HDI trimer), (90% in solvent mixture): NCO |
| | content ca. 17.3 to 18.3%, equivalent weight ca. 236 g/mol |
| 5 | Hydroxyl group-containing polyacrylate (65% in solvent mixture): acid |
| | number 4-9 mg KOH/g, OH content 2.6-3.4% |
| 6 | Free acid of a complex alkyl phosphate ester, 66% in solvent |
| 7 | Diacetone alcohol |
| 8 | Mixture of 55-65% dimethyl glutarate, 15-25% dimethyl succinate and |
| | 10-25% dimethyl adipate |
| 9 | Corrosion-protection pigment based on calcium silicate |
| 10 | silica |
| 11 | Conductive pigment: graphite |
| 12 | Tannin-containing wetting agent, 22% in solvent |
| 13 | Barium dinonylnaphthalene sulfonate, 50% in solvent |

The agents can also be formulated without conductive pigment (component 11). Then the component 11 is not used in the compositions according to examples 1 to 6 and the quantities of the other components are recalculated in parts by weight.

1. A composition of matter which comprises:
organic resin components dissolved and/or dispersed in an organic solvent or mixture of solvents, said organic resin components comprising:
A. an epoxy resin based on a bisphenol-epichlorohydrin polycondensation product and present as a hydroxyl group-containing polyether,
B. a blocked aliphatic polyisocyanate,
C. an unblocked aliphatic polyisocyanate,
D. at least one reaction component selected from hydroxyl group-containing polyesters and hydroxyl group-containing poly(meth)acrylates.

2. The composition according to claim 1, wherein the organic resin components A to D are present in weight ratios of:
A:B=1:0.8 to 1:1.3
C:D=1:1.4 to 1:2.3.

3. The composition according to claim 1, wherein the organic resin components A to D are present in weight ratios of:
A:D=1:2 to 1:6 and
B:C=1:0.5 to 1:5.

4. The composition according to claim 1, additionally comprising a conductive pigment or a mixture of conductive pigments.

5. The composition according to claim 4, said conductive pigment or said mixture of conductive pigments being present in an amount, based on total weight of the composition, of 0.8ρ to 8ρ wt. %, where “ρ” is density of said conductive pigment or mean density of said mixture of conductive pigments in g/cm³.

6. The composition according to claim 4, wherein the mixture of conductive pigments comprises:
a first conductive pigment having a density of less than 3 g/cm³; and
a second conductive pigment having a density greater than 4 g/cm³;
wherein said composition comprises a total amount of conductive pigment, based on total weight of the composition, of 0.8ρ to 8ρ wt. %, where “ρ” is mean density of the mixture of conductive pigments in g/cm³.

7. The composition according to claim 4 wherein, based on total weight of the composition:
the organic solvent or mixture of solvents is present in an amount ranging from 25 (an adjustment coefficient) to 60 (the adjustment coefficient) in wt. %; and
said organic resin components are present in an amount ranging from 20 (the adjustment coefficient) to 45 (the adjustment coefficient) wt. %;
where said adjustment coefficient is (100-2.8ρ):93.85, where “ρ” is density of the conductive pigment or mean density of the mixture of conductive pigments in g/cm³; and
wherein weight fractions of said organic resin components and said organic solvent or mixture of solvents summed are not greater than 93 (the adjustment coefficient) wt. %.

8. The composition according to claim 4 wherein, based on total weight of the composition, the resin component a) is present in an amount ranging from 2(adjustment coefficient) to 8(adjustment coefficient) wt. %, where said adjustment coefficient is (100-2.8ρ):93.85, where “ρ” is density of the conductive pigment or mean density of the mixture of conductive pigments in g/cm³.

9. The composition according to claim 4 wherein, based on total weight of the composition, the resin component a) is present in an amount ranging from 5(adjustment coefficient) to 25(adjustment coefficient) wt. %, where said adjustment coefficient is (100-2.8ρ):93.85, where “ρ” is density of the conductive pigment or mean density of the mixture of conductive pigments in g/cm³.

10. The composition according to claim 4 additionally comprising, based on total weight of the composition, a filler selected from silicic acids, silicon oxides, aluminum oxides, titanium dioxide and barium sulfate present in an amount ranging from 0.1(adjustment coefficient) to 3(adjustment coefficient) wt. %, wherein the adjustment coefficient is (100-2.8ρ):93.85, where “ρ” is density of the conductive pigment or mean density of the mixture of conductive pigments in g/cm³.

11. The composition according to claim 4 comprising lubricants and/or shaping aids, present in an amount ranging from 0.5(adjustment coefficient) to 20(adjustment coefficient) wt. %, wherein the adjustment coefficient is (100-2.8ρ): 93.85, where “ρ” is density of the conductive pigment or mean density of the mixture of conductive pigments in g/cm³.

12. The composition according to claim 1, comprising no conductive pigment.

13. A process for manufacturing a coated metal panel or component, comprising wherein the panel or component to be coated
i) optionally cleaning a metal panel or component;
ii) contacting the metal panel or component with a conversion solution, thereby generating a conversion layer comprising not more than 1 mg chromium per m², on said metal panel or component and then with or without an intervening rinse;
iii) coating the conversion layer with a composition according to claim 1 and curing at a substrate temperature ranging from 120 to 260° C.

14. The process according to claim 13, wherein the metal panel is a strip-shaped metal panel; at least steps ii) and iii) are performed as strip treatment methods, and in step iii) the composition is applied in a quantity such that after curing, a layer thickness ranging from 0.5 to 10 μm is obtained.

15. The process according to claim 13, wherein the metal of the panel or component is selected from aluminum, an aluminum alloy, zinc, a zinc alloy, steel, steel coated with zinc, steel coated with aluminum, and steel coated with alloys of zinc or aluminum.

16. A coated panel or component obtained in accordance with the process according to claim 13.

17. A process for manufacturing a coated metal panel or component, comprising wherein the panel or component to be coated
i) optionally cleaning a metal panel or component;
ii) contacting the metal panel or component with a conversion solution, thereby generating a conversion layer comprising not more than 1 mg chromium per m², on said metal panel or component and then with or without an intervening rinse;
iii) coating the conversion layer with a composition according to claim 12 and curing at a substrate temperature ranging from 120 to 260° C.
wherein the metal panel is a strip-shaped metal panel; at least steps ii) and iii) are performed as strip treatment methods, and in step iii) the composition is applied in a quantity such that after curing, a layer thickness in the range from 0.5 to 3 μm is obtained.
